(19) United States
(12) Patent Application Publication
(10) Pub. No.: US 2024/0252392 A1
(43) Pub. Date: Aug. 1, 2024

(54) PORTABLE SOLENOID ACTUATED IMPULSE TREATMENT DEVICE AND USE THEREOF

(71) Applicant: Neuro Spinal Innovation Inc., Mississauga (CA)

(72) Inventor: Aslam KHAN, Mississauga (CA)

(73) Assignee: Neuro Spinal Innovation Inc., Mississauga (CA)

(21) Appl. No.: 18/160,260

(22) Filed: Jan. 26, 2023

(51) Int. Cl. A61H 23/00; A61H 23/02

(52) U.S. Cl. CPC A61H 23/006; A61H 23/0218; A61H 2201/0138; A61H 2201/1664; A61H 2201/1673; A61H 2201/5007; A61H 2201/5046; A61H 2201/5058; A61H 2201/5097

(57) ABSTRACT

An impulse treatment device is provided, the impulse treatment device comprising an articulating holding arm, an impulse treatment head and a stylus wherein the articulating holding arm includes: a proximal joint for rotational attachment to the cart and which includes a ball joint which includes a ball, a socket, a spring to bias the ball to a locked position, and a linear solenoid to release the ball; a long proximal section, which defines a bore and is attached to the proximal joint; a short distal section which defines a bore and includes a distal end; and a pair of ball joints between the short distal section and the long proximal section, wherein the ball joints each include a ball, a spring to bias the ball to a locked position, and a socket and a linear solenoid.

### FIELD

The present technology is a portable impulse treatment device that includes a treatment head that can also be handheld. More specifically, it is a device that includes an articulating holding arm that can be positioned with one hand to provide highly repeatable positioning of the treatment head regardless of the position of the patient on the treatment table.

### BACKGROUND

United States patent Application Publication Nos. 20200230012, 20170281450, 20160242985, 20140031866 and 20090005812 disclose a portable battery power operated chiropractic adjusting instrument, manipulator or thruster for applying a selectable adjustment energy impulse to a patient through a plunger having a resilient or cushioned head with the energy impulse applied to the plunger being supplied by a solenoid. The adjusting instrument can have annunciators or indicators for preload, readiness to operate, level of energy impulse and the like. The power source can be an internal rechargeable battery or removable rechargeable battery pack. This is a handheld device. There is no mechanism to adjust the force being exerted on the patient, nor is there any mechanism to ensure accurate and repeatable treatments.

United States patent Application Publication No. 20190142692 discloses a system for treating soft tissue of a patient. The system includes a treatment head and a computer portion. The treatment head includes a probe and an electrode operably coupled to the probe. The probe and electrode are configured to respectively deliver a mechanical force impulse and an electrical stimulation to the soft tissue when placed in operable contact with the soft tissue. The computer portion includes a CPU and is configured to coordinate the delivery of the mechanical force impulse and electrical stimulation relative to each other. The system is configured to sense a shockwave in the soft tissue of the patient, the shockwave resulting from the mechanical force impulse delivered to the soft tissue via the probe. The system is also configured to analyze a characteristic of the sensed shockwave and configure the electrical stimulation to be delivered to the soft tissue via the electrode based on the characteristic analysis of the sensed shockwave. The characteristic may be at least one of frequency of the sensed shockwave, amplitude of the sensed shockwave, and/or wave shape (form) of the sensed shockwave. This is a handheld device and suffers all the deficiencies associated with a handheld device.

United States patent Application Publication No. 20180360684 discloses a percussive adjusting instrument is provided which includes a percussive instrument head and a traversing arm that couples to the percussive instrument head. The percussive instrument head is movable with respect to the traversing arm. A vertical arm supports the traversing arm. The vertical arm also pivots the traversing arm and the percussive instrument head about an axis. A pivot assembly allows movement of the vertical arm and the percussive instrument head. This application discloses the use of a laser light for aiming the stylus. This device is large, non-mobile and relies heavily on the correct placement of the patient. Further, it requires adjustment of numerous components using two hands and is only adjustable in the X, Y and Z planes.

United States patent Application Publication No. 20140188169 discloses a cordless chiropractic adjustment device including a thrust element (80) capable of impacting a body contact member (10), a resilient spring (314) arranged to bias the thrust element towards the body contact member, and a motor (120). The motor is arranged to move the thrust element between a variable primed configuration in which the thrust element is held out of contact with the body contact member, and a fired configuration in which the thrust element is propelled by the resilient spring into contact with the body contact member through a range of different impact forces. The motor is provided with direct current by one or more batteries (150), which may be rechargeable. This is a relatively rudimentary device and is handheld.

United States patent Application Publication No. 20130158602 discloses a chiropractic apparatus that is not only easily portable, but also enables even a chiropractor not having a high level skill to perform easily a safe, correct and effective adjustment of any bone of a patient without causing a pain. The chiropractic apparatus includes: a chiropractic adjuster means containing a thrust member having a thrust head and a release-surface means attached to the chiropractic adjuster means, the release-surface means having a surface for forming a release surface. When a longitudinal forward thrust is applied to the thrust member so as to give a thrust to a body surface, the release-surface means and the thrust head are subjected to relative movement with respect to each other, whereby a release surface including the surface for forming a release surface is formed around the thrust head, the release surface having at least a part thereof placed in contact with the body surface. This is a handheld device and suffers all the deficiencies of a handheld device.

United States patent Application Publication No. 20130131724 discloses a chiropractic apparatus including a chiropractic adjuster means and a contact means. The contact means being capable of relative movement with respect to the chiropractic adjuster means, the contact means having a forward end portion that is capable of contacting both the tip of a palpation finger of a user and a body surface of a patient, the contact means having a targeting space that is capable of receiving the tip and causing the palpation fingertip to be placed in contact with the body surface. The targeting space receiving the forward end portion of the chiropractic adjuster means and causing the forward end portion to be placed in contact with the body surface. By subjecting the contact means and the chiropractic adjuster means to relative movement, the chiropractic adjuster means is capable of moving to the targeting space of the contact means and placed in contact with the body surface. This is a relatively rudimentary device.

United States patent Application Publication No. 20060293711 discloses a portable power operated chiropractic adjustor, manipulator or thruster for applying an adjustment energy to a patient through a plunger having a resilient or cushioned head with the energy applied to the plunger being supplied by non-manual sources and the impulse is adjustable or tunable along with having annunciators or indicators for preload and readiness to operate. The adjustor also allows for settings of single or multiple strokes. The power source may be internal such as from a rechargeable battery, removable rechargeable battery pack, or air cartridge depending on whether it is electrically or pneumatically operated. This is a relatively rudimentary device.

U.S. Pat. No. 8,152,747 discloses a spinal and upper cervical impulse treatment device and controller, which delivers multiple impulses of variable frequency and variable force in a linear direction, as well as rotational forces, for patient treatment. Known chiropractic impulse devices are all hand-held devices. In contrast, the spinal and upper cervical impulse treatment device is mounted on a fixed stand and armature, allowing reliable positioning and directional alignment in three dimensions. Fixed mounting also facilitates ease of use. A safety coupling is incorporated to avoid patient injury due to excessive force on the treatment site in the fixed mounting scenario Smooth sinusoidal waveforms are a preferred waveform for impulse delivery and sine waves are generated digitally in the apparatus. Data validation is used to ensure correct directional alignment prior to device activation Patient safety and consistency in treatment protocols are considered in the spinal and upper cervical impulse treatment design. This device requires two hands to position the treatment head and only functions to position the treatment in the X, Y and Z planes.

U.S. Pat. No. 5,020,933 discloses an apparatus useful in surgery for holding retractors and other surgical instrumentation in a number of different positions required by a surgeon for the performance of a surgical procedure, including advanced sensing and regulation of retraction pressures and position; and incorporating a force amplification method to drive a locking mechanism in the supporting structure that utilizes a constrained, substantially incompressible, flexible solid material to yield a mechanism that is suitable for clinical use. The apparatus is overly complex and requires access to compressed air.

U.S. Pat. No. 6,379,073 discloses a positionable arm composed of multiple member segments connected by an adjustable joint which may be fixedly positioned and repeatedly repositioned. The first member includes an end portion defining a first connector opening and an inner surface defining a chamber. A slidable piston provided in the first member includes a first end and a second end, the first end being adjacent the chamber and creating a seal along the inner surface of the first member. A rotatable connector is received in the first member between the second end of said piston and the end portion of the first member, and a second member is attached to the rotatable connector. To position the arm, a pressurized fluid source supplies compressed air to the chamber, which presses the piston against the rotatable connector, fixedly clamping the connector between the piston and the end portion of the first chamber. The positionable arm is overly complex and requires a source of pressurized fluid.

U.S. Pat. No. 6,491,273 a multi-joint arm-like support including a mount connecting to an elongate first limb section by a paired ball-and-socket joint, or shoulder joint. The first limb section is connected to a second limb section by a rotatable joint or elbow joint. The second limb section has a ball-and-socket joint connecting to an instrument mount. The joints include fluid activated locks to enable the arm to be freely moveable when the fluid activated locks are released and locked in position when the fluid activated locks are activated. The support is overly complex and requires a source of pressurized fluid.

What is needed is an impulse treatment device that is portable and includes a treatment head that could also be handheld. It would be preferable if it was retained on a stand with an articulating holding arm to provide positioning in all planes and orientations. It would be preferable if it allowed for patient treatment regardless of the patient's position on the treatment table. It would be further preferable if the treatment head could be positioned with one hand, whether the left or the right hand. It would be further preferable if the articulating holding arm had graduated locking mechanisms that were controlled by at least one release mechanism located on a short section of the articulating holding arm proximate to the treatment head. It would be further preferable if the articulating holding arm could be locked to the stand to allow the stand to be repositioned without damaging the arm. It would be further preferable if the impulse treatment head was a smart impulse treatment head. It would be further preferable if the impulse treatment head included a compensatory mechanism. It would be further preferable if the impulse treatment device allowed for repeatable alignment and treatment. It would be further preferable if the impulse treatment device included at least one computing unit.

### SUMMARY

The present technology is an impulse treatment device that is portable and includes a treatment head which can also be handheld. It is rotatably retained on a stand with an articulating holding arm to provide positioning in all planes and orientations. This allows for patient treatment regardless of the patient's position on the treatment table. The articulating holding arm has three sections, a long proximal section, a long middle section and a short distal section with ball joints between the sections. The short distal section includes at least one release mechanism for the ball joints. The treatment head can be positioned with one hand, whether left or right, by the user releasing the ball joints with one hand and moving the articulating arm in order to position the treatment head. The articulating holding arm has graduated locking mechanisms. The articulating holding arm can be locked to the stand to allow the stand to be repositioned without damaging the arm. The impulse treatment head is a smart impulse treatment head. The impulse treatment head includes a compensatory mechanism. The impulse treatment device allows for repeatable alignment and treatment. The impulse treatment device includes firmware and the system further includes a computing device.

In one embodiment an impulse treatment device is provided for use with a cart, the impulse treatment device comprising an articulating holding arm, an impulse treatment head and a stylus wherein
the articulating holding arm includes: a proximal joint for rotational attachment to the cart and which includes a ball joint which includes a ball, a socket, a spring to bias the ball to a locked position, and a linear solenoid to release the ball; a long proximal section, which defines a bore and is attached to the proximal joint; a short distal section which defines a bore and includes a distal end; and a pair of ball joints between the short distal section and the long proximal section, wherein the ball joints each include a ball, a spring to bias the ball to a locked position, a socket and a linear solenoid to release the ball; a bent arm extending between and attached to each of the balls of the pair of ball joints and wherein the articulating holding arm has a full range of motion and can be locked in any orientation;
the impulse treatment head includes: a distal end; a proximal end; a body therebetween; a touch screen on the proximal end; an actuator for driving the stylus in a linear direction; an internal motion unit (IMU), the impulse treatment head attached to the distal end of the distal section of the articulating holding arm;
the stylus is slidably, releasably retained in the impulse treatment head and extends outward at the distal end and is releasably coupled to the actuator.

In the impulse treatment device, the articulating holding arm may further comprise a long middle section which defines a bore; a pair of ball joints between the long middle section and the long proximal section, wherein the ball joints each include a ball, a spring to bias the ball to a locked position, and a linear solenoid to release the ball; and a bent arm extending between and attached to each of the balls of the pair of ball joints.

In the impulse treatment device, the impulse treatment head may be attached at right angles to the distal section.

In the impulse treatment device, the impulse treatment head may further comprise a radio frequency identification (RFID) transponder and the stylus further comprises an RFID tag.

In the impulse treatment device, the treatment head may further comprise an internal motion unit (IMU).

In the impulse treatment device, the treatment head may further comprise firmware, the firmware in electronic communication with the IMU and configured to determine an orientation of the stylus and calculate a difference between the orientation and an angle of attack.

In the impulse treatment device, the treatment head may include a touchscreen on the proximal end for adjusting and displaying the angle of attack.

In the impulse treatment device, the short distal section may further comprise at least one controller, the controller in electrical communication with the linear solenoids of the ball joints.

In the impulse treatment device, the impulse treatment head may be releasably attached to the distal end of the short distal section.

In the impulse treatment device, a release mechanism for the impulse treatment head may be located on the short distal section.

In another embodiment, an articulating holding arm is provided for use with a medical treatment device, the articulating holding arm comprising: a proximal joint for rotational attachment to a support and which includes a ball joint, the ball joint including a ball, a socket, a spring to bias the ball to a locked position, and a linear solenoid to release the ball; a long proximal section, which defines a bore and is attached to the proximal joint; a short distal section which defines a bore and includes a distal end; and a pair of ball joints between the short distal section and the long proximal section, wherein the ball joints each include a ball, a socket, a spring to bias the ball to a locked position, and a linear solenoid to release the ball; and a bent arm extending between and attached to each of the balls of the pair of ball joints, wherein the articulating holding arm has a full range of motion and can be locked in any orientation.

In the articulating arm, the ball joints may further comprise an O-ring, the O-ring disposed between the ball and the socket.

The articulating holding arm may further comprise a long middle section which defines a bore; a pair of ball joints between the long middle section and the long proximal section, wherein the ball joints each include a ball, a spring to bias the ball to a locked position, and a linear solenoid to release the ball; and a bent arm extending between and attached to each of the balls of the pair of ball joints.

In the articulating arm, the short distal section may further comprise at least one controller, the controller in electrical communication with the linear solenoids of the ball joints.

In the articulating arm, the distal end of the short distal section may include a retention mechanism for retaining a medical device.

In the articulating arm, a release mechanism for the retention mechanism may be located on the short distal section.

In the articulating arm, the proximal joint may be rotatably and articulately mounted to a mounting bracket which may be configured to retain the articulating holding arm on a support.

In another embodiment, an impulse treatment system is provided, for use with a cart, the impulse treatment system comprising, an articulating holding arm, an impulse treatment head, a computing device and a stylus, wherein
the articulating holding arm includes a proximal section, a middle section and a distal section and is configured to have a full range of motion, to be lockable in any orientation and to releasably retain the impulse treatment head on the distal section;
the impulse treatment head includes a proximal end, a distal end, an actuator for driving the stylus in a linear direction, firmware, a touchscreen in electronic communication with the firmware, the touchscreen located on the proximal end, and an IMU in electronic communication with the firmware, wherein the firmware is configured to record and report a treatment vector to the computing device;
the computing device includes software which is configured for calibrating and training the firmware and is in wired or wireless communication with the firmware in the impulse treatment head; and
the stylus is slidably, releasably retained in the impulse treatment head and extends outward at the distal end and is releasably coupled to the actuator.

The impulse treatment system may further comprise the cart.

In another embodiment, the impulse treatment system is used for the treatment of a patient, wherein:
the computing device provides a treatment vector to the firmware in the impulse treatment head;
a user positions the impulse treatment head by adjusting the articulating holding arm;
the user aligns the treatment vector by viewing the display on the touchscreen of the impulse treatment head and adjusting the position of the impulse treatment head;
the user selects a treatment protocol;
and the patient is treated.

In another embodiment, a use of an impulse treatment system is provided for the treatment of a patient, the impulse treatment system comprising a handheld impulse treatment head, a stylus and a computing device,
the handheld impulse treatment head including: a distal end; a proximal end; a body therebetween; a touch screen on the proximal end; an actuator for driving the stylus in a linear direction; an IMU, firmware and a wireless radio;
the stylus is slidably, releasably retained in the impulse treatment head and extends outward at the distal end and is releasably coupled to the actuator;
and the computing device includes a database of patient treatment vectors and is in wireless communication with the firmware in the impulse treatment head,
wherein:
the computing device provides a treatment vector to the firmware in the impulse treatment head;
a user positions the handheld impulse treatment head on the patient;
the user aligns the treatment vector by viewing the display on the touchscreen of the handheld impulse treatment head and adjusting the position of the handheld impulse treatment head;
the user selects a treatment protocol;
and the patient is treated.

The use may further comprise the computing device calibrating and training the firmware in the handheld impulse treatment head.

### BRIEF DESCRIPTION OF DRAWINGS

FIG. 1 is a perspective view of the impulse treatment system of the present technology.

FIG. 2 is another perspective view of the impulse treatment system of the present technology.

FIG. 3 is a perspective view of impulse treatment head of the impulse treatment device.

FIG. 4A is a side view of the distal section and the treatment head.

FIG. 4B is an end view of an alternative embodiment of the distal end of the distal section.

FIG. 5 is a schematic of the impulse treatment system of FIGS. 1 and 2.

FIG. 6 is a schematic of the impulse treatment head.

FIG. 7 is an exploded view of the stylus.

FIG. 8A is a longitudinal sectional view of the ball joint.

FIG. 8B is a longitudinal sectional view of the ball joint.

FIG. 9 is a plan view of the touch screen of the computing device.

FIG. 10 is a plan view of the touch screen of the treatment head.

FIG. 11 shows the alignment dial on the touch screen of the treatment head out of alignment with the longitudinal axis of the patient.

FIG. 12 shows the alignment dial on the touch screen of the treatment head in alignment with the longitudinal axis of the patient.

FIG. 13 shows the vector alignment dial on the touch screen of the treatment head as the vector of the stylus on the treatment head is aligned with the target vector.

FIG. 14 is a schematic of an alternative embodiment of FIGS. 1 and 2.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

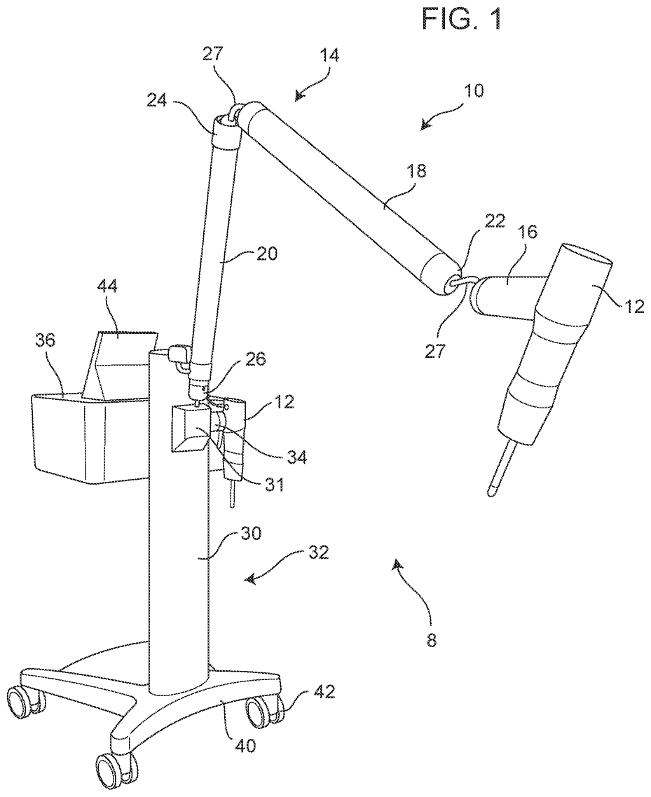

An impulse treatment system, generally referred to as 8 is shown in FIG. 1. It includes an impulse treatment device, generally referred to as 10, that includes a treatment head 12 and an articulating holding arm, generally referred to as 14. The treatment head 12 is releasably attached to the articulating holding arm 14. The articulating holding arm 14 has three sections, a distal section 16, which is short (about 300 millimeters in one embodiment), a middle section 18, which is long (about 700 millimeters in one embodiment) and a proximal section 20 of intermediate length about 500 millimeters in one embodiment), giving a ratio of about 3:7:5. A distal joint 22 is between the distal section 16 and the middle section 18, a middle joint 24 is between the middle section 18 and the proximal section 20 and a proximal joint 26 is between the proximal section 20 and the cart 30. The distal joint 22 is a pair of ball joints with a bent arm 27 extending between the ball joints, the middle joint 24 is also a pair of ball joints with a bent arm 27 extending between the ball joints and the proximal section 20 and the proximal joint 26 is a single ball joint. These allow the treatment head 12 to be positioned in any orientation. The treatment head 12 is releasably attached to the distal end 28 of the distal section 16 and is at right angles to the distal section 16. Without being bound to theory, a greater degree of accuracy can be obtained by having the treatment head 12 at right angles to the distal section 16. The proximal section 20 is rotatably and articulately attached to a mounting bracket 31 which in turn in mounted on the tower 30, which is part of a cart, generally referred to as 32. This allows for rotation and swiveling. The bracket 31 can be manually moved vertically to adjust for different treatment table heights. A bracket 34 on the tower 30 releasably retains the treatment head 12 or a second treatment head 12.

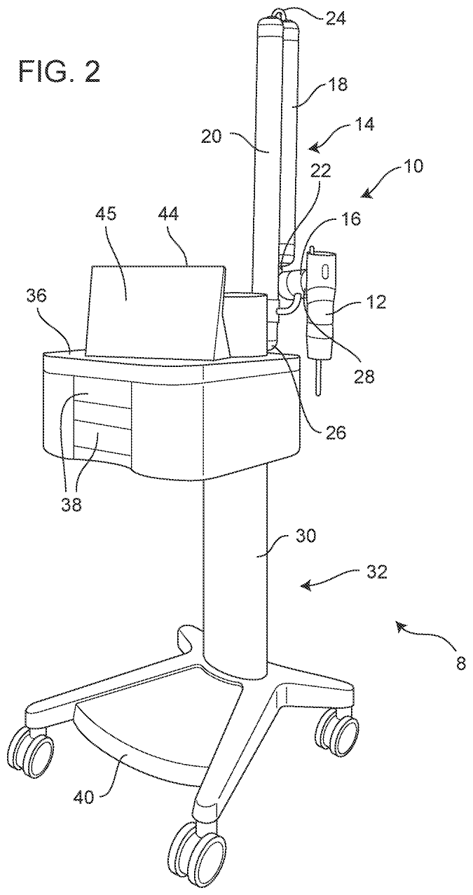

As shown in FIG. 2, the cart 32 includes a worksurface 36, the tower 30, two drawers 38, a base 40 and four lockable wheels 42. A computer 44, with a touchscreen 45 sits on the worksurface 36. Alternatively, the computer 44 is inside the drawer 38, with the touchscreen 45 mounted on the tower 30 either directly or with a short articulating arm.

The impulse treatment device 10 is intended to help with pain and/or neuromusculoskeletal (NMSK) dysfunction caused by non-congenital defects. The device can be used as part of a sequence of steps in a patient's overall care. The impulse treatment system 8 is a non-invasive product used to deliver precise mechanical impulses at a required vector configuration during the treatment.

Low-intensity mechanical impulses are applied to the treatment site in a controlled and repeatable manner by the impulse treatment device 10. The direction (vector), amplitude, and duration of the impulses can all be controlled to apply a known, finite, and predetermined amount of force and/or energy to the treatment site. This is a predetermined control that is prescribed by a certified health practitioner.

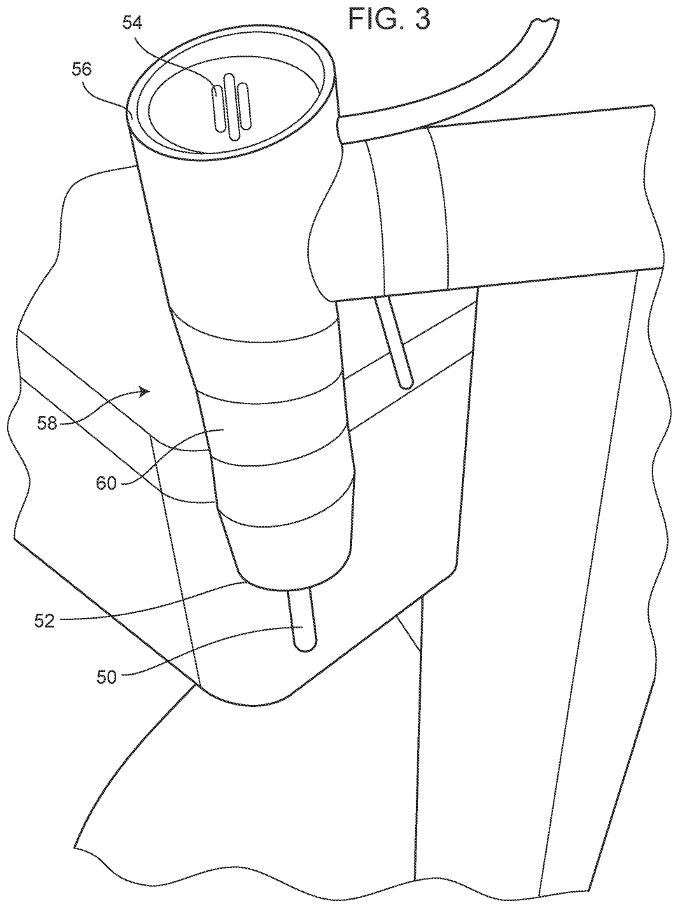

As shown in FIG. 3, the treatment head 12 releasably retains a stylus 50, which is part of the impulse treatment device 10, on the head distal end 52. It has a liquid crystal display (LCD) touch screen 54 on the head proximal end 56. The body, generally referred to as 58, includes a holding zone 60 which is a zone that is covered with a compliant material.

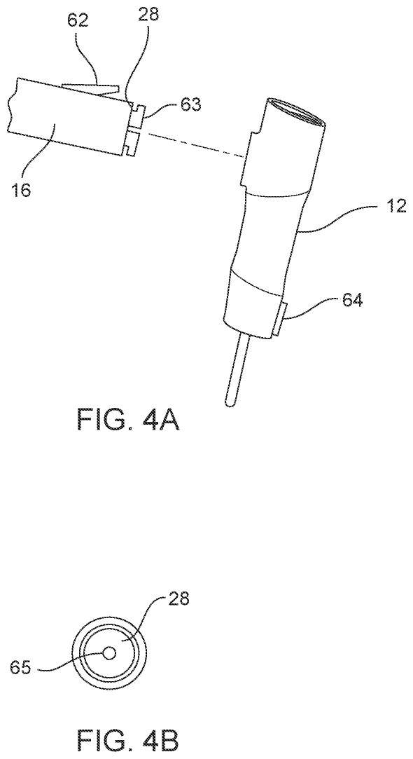

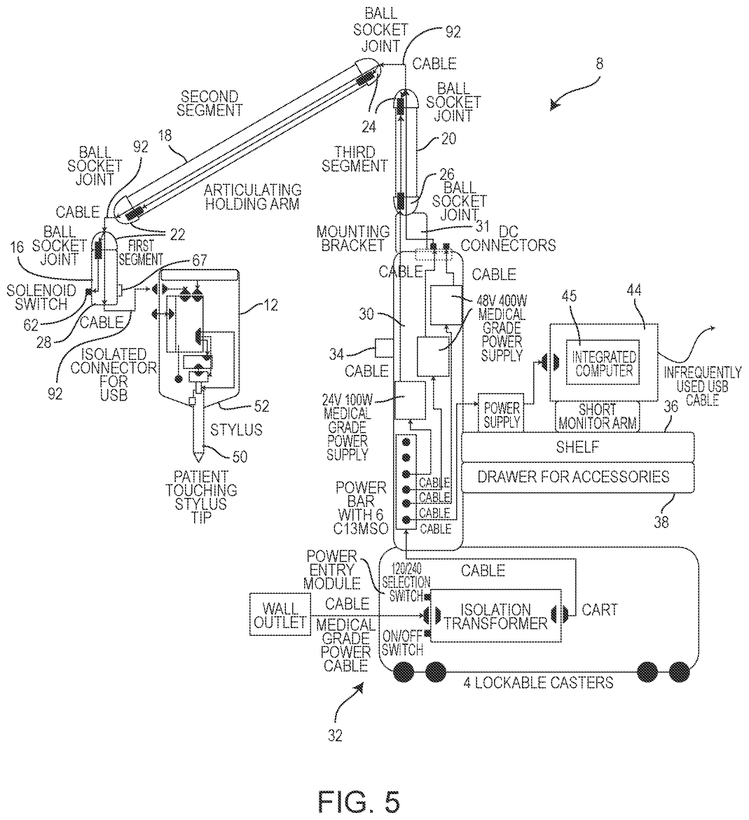

As shown in FIG. 4A, a release mechanism 62 is located proximate to the distal end 28 of the distal section 16. The release mechanism 62 is a lever or a button which releases the treatment head 12 and is in communication with a retention mechanism 63 which may be a lever. The treatment head 12 is non-rotatably attached to the distal end 28. A laser diode 64 is mounted in parallel to the stylus 50, with or without an offset. In one embodiment there may be two laser diodes. As shown in FIG. 4B, in an alternative embodiment a poly-magnet or a neodymium magnet 65 is used to releasably retain the treatment head 12 on the distal end 28 of the distal section 16. A Hall sensor is located in the treatment head 12 to sense the rare earth magnet. In an alternative embodiment a bayonet mount is used. In another embodiment the treatment head 12 is threadedly attached to the distal end 28.

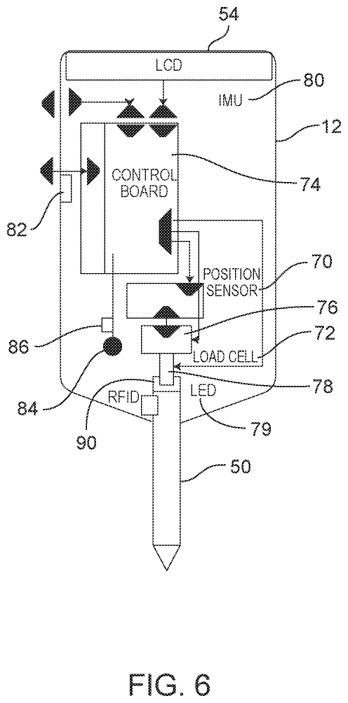

FIG. 5 shows a schematic of the impulse treatment system 8. One or more controllers 67, which may be levers or buttons are located on the distal section 16 and operate the articulating holding arm 14. The joints 22, 24 and 26 have a graduated locking mechanism, with the proximal joint 26 having the highest resistance, the middle joint 24 having the intermediate resistance and the distal joint 22 having the lowest resistance. In this manner, when the joints are unlocked, the articulating holding arm 14 does not collapse. A power cord 92 is routed through the distal section 16, the middle section 18 and the proximal section 20 to deliver power to the treatment head 12.

The distal section 16 allows for the user to grasp it with one hand, actuate the controller 67 with a finger to release the force on the joints 22, 24, 26 and orient the treatment head 12. The proximal section 20 allows for swiveling for orientation and movement off the vertical for example about to 45-60 degrees, to accommodate all of the potential treatment head 12 orientations. The middle section 18 allows for extending the reach and for orientation. The distal section 16 allows for fine adjustment of the treatment head 12. The articulating holding arm 14 has a full range of motion. The treatment head 12 can be held in any orientation. This allows a patient to be treated in any position, including but not limited to sitting, supine, prone, on the left side, and on the right side, on the treatment table. Doing so allows the practitioner to treat any patient and not just one that can lie on their right or left side.

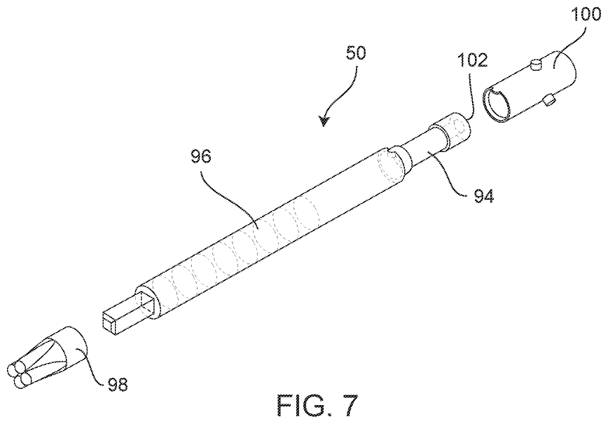

As shown in FIG. 6, the treatment head 12 includes a position sensor 70 to track the motion of an electromagnetic voice coil 76, a load cell 72 to measure the force of the stylus 50 on the patient, firmware 74, the touchscreen 54, the voice coil 76 that drives the stylus 50 and a coupling 78 between the stylus 50 and the voice coil 76 for releasably retaining the stylus 50. In an alternative embodiment the voice coil 76 is replaced with a linear solenoid as the actuator. Red-green-blue light emitting diodes 79 are housed in the treatment head 12 and illuminate the stylus 50 under control of the firmware 74 and/or the computer 44, with red indicating a higher than acceptable pressure and green indicating appropriate pressure. An internal motion unit (IMU) 80 is also housed in the treatment head 12 and is in electronic communication with the firmware 74 and/or computer 44. The IMU 80 can detect if the treatment head 12 is dropped, can assist in the correct positioning of the treatment head 12, provides feedback regarding the force and amplitude of the vibration of the stylus 50 and provide additional monitoring. The position sensor 70, the load cell 72 and the IMU 80 are in electronic communication with the firmware 74 and/or the computer 44 and allow the treatment head 12 to know its location and to repeat that location for subsequent treatments. A Hall type sensor 82 confirms that the treatment head 12 is attached to the articulating arm 14. Also included in the treatment head 12 is a radio frequency identification (RFID) transponder 84 and a wireless radio 86, which may be a Bluetooth® radio. A compensatory mechanism 90 is located between the stylus 50 and the voice coil 76. If the force exceeds the safety limit set in the device 10 or the force of the treatment, the stylus 50 can retract into the treatment head 12. In an alternative embodiment the compensatory mechanism is between voice coil 76 and the touchscreen 54. In another alternative embodiment the compensatory mechanism is about the stylus 50 outside the body 58 of the treatment head 12. Retraction can be up to an inch. Similarly, if the force being exerted is lower than the treatment is supposed to be, the stylus 50 can be pushed out of the treatment head 12 up to one inch. In one embodiment, the compensatory mechanism is mechanical, for example, a compression spring assembly. In another embodiment, the compensatory mechanism is electric. In both mechanisms, a force sensor, for example a piezo electric force sensor is in electronic communication with the firmware 74 and/or computer 44. When there is an exceedance, or the pressure is too low the firmware 74 and/or the computer 44 signal the compensatory mechanism to react. In an alternative embodiment the compensatory mechanism is mechanical, for example, a spring. This is especially important when the treatment head 12 is hand-held.

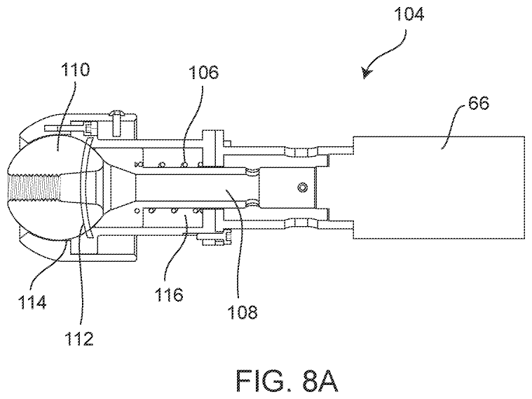

As shown in FIG. 7, the stylus 50 includes a radio frequency identification (RFID) tag 94 that is imbedded in the shaft 96. In use, the RFID tag 94 is read by the RFID transponder 84. In this manner, the number of treatments, the types of treatments, the age of the stylus, the patient identification and the like can be tracked for each stylus 50. There are different stylus designs, including a single tip 98 with a diameter of about 5 to about 8 millimeters, a flattened tip with a diameter that is greater than 1 centimeter, a rounded tip with a diameter that is greater than 1 centimeter, a dual tip, and a triple tip. The tip 98 is releasably retained on the shaft 96. The stylus 50 is releasably retained on the treatment head 12 with a bayonet connection which is biased with a light spring, hence as shown, a bayonet cap 100 is mounted on the proximal end 102 of the shaft 94.

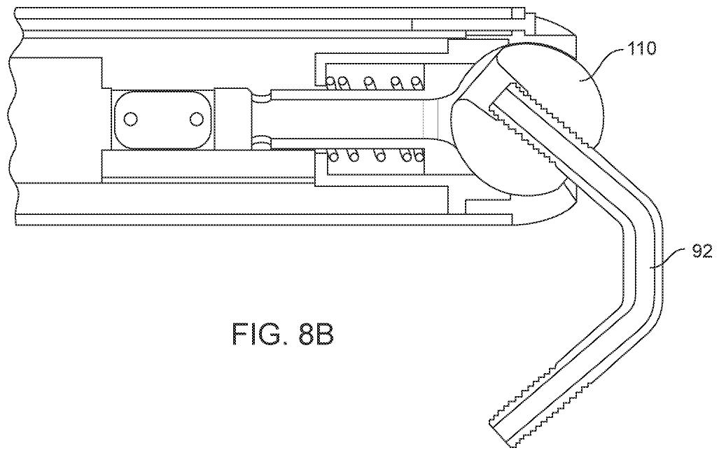

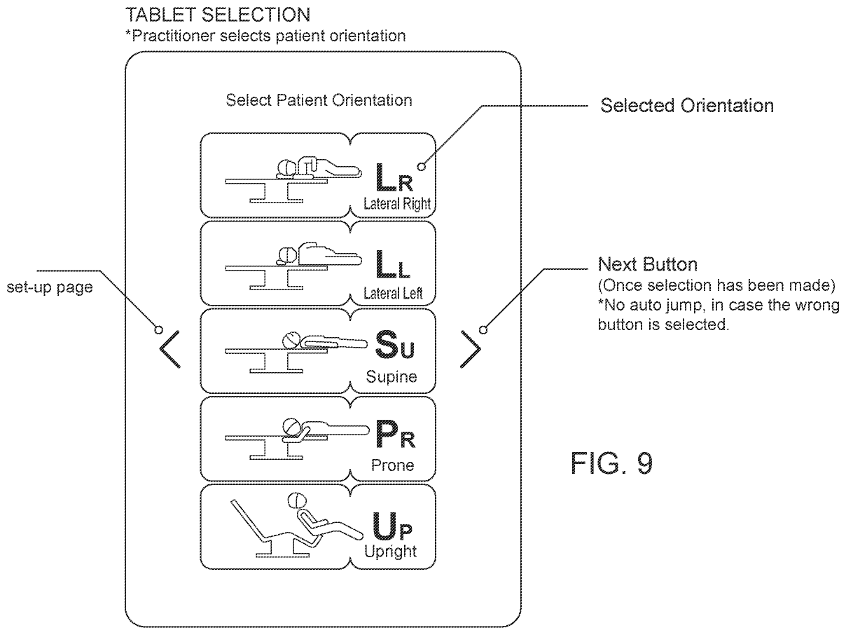

The details of the ball joints 104 of the distal joint 22, the middle joint 24 and the proximal joint 26 are shown in FIG. 8A. Each joint 22, 24 and 26 is controlled by a linear solenoid actuator 66. A spring 106 biases a locking mechanism, which in one embodiment is a piston 108 to maintain friction normal to the ball 110. In addition, an O-ring 112 is located between the ball 110 and the socket 114 to increase friction. The linear solenoid actuator 66, under control of a switch, retracts the locking mechanism 108 from the ball 110 as it moves back along the bore 116 of each of the distal section 16, the middle section 18 and the proximal section 20. An anti-rotation force is applied to the rear of the ball joint via the piston 108 with an identical diameter recess to match the ball joint 22, 24, 26. The spring 106 applies force onto the piston 108 and prevents movement while continuously applying force onto the ball joint. The piston 108 is connected to the linear solenoid 66. In its non-energized state the linear solenoid 66 applies no force onto the assembly. In its energized state, the linear solenoid 66 pulls the piston 108 back and overcomes the force applied by the spring 106. This allows the ball joint to move freely.

As shown in FIG. 8B, the power cord 92 passes through the ball 114 and into the bore 116 of each section. In alternative embodiments, the power chord can be external or can be partially enclosed and partially external.

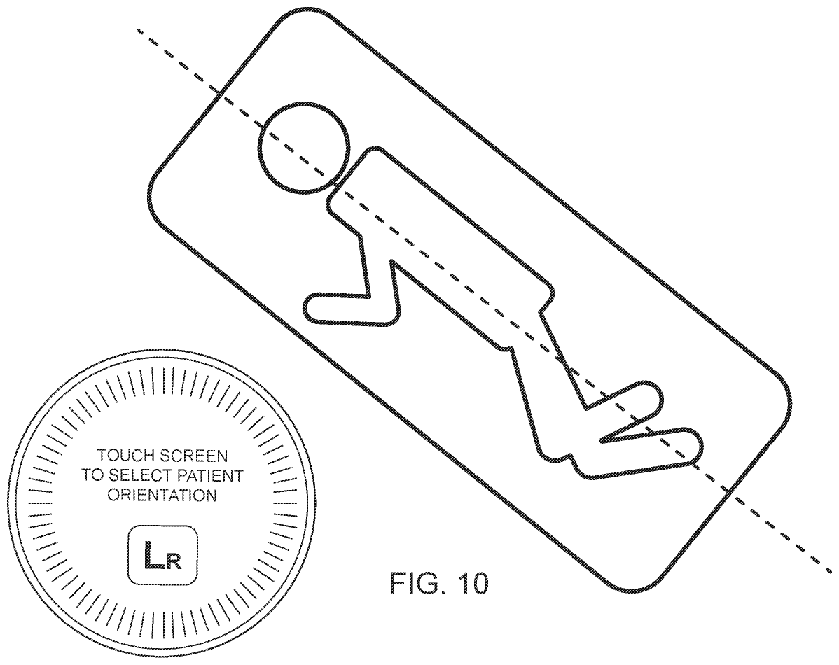

The method of using the impulse treatment device 10 is shown in FIGS. 9 to 13. The treatment, which includes a target vector, for a patient is either determined through an assessment of the patient before the treatment or is obtained from a database that contains patient information. This patient information includes the target vector to be used when treating the patient and defines an orientation in three-dimensional space in relation to the position of the patient. The treatment is defined by a list of treatment parameters.

The treatment parameters are defined as below:
Amplitude (The amplitude of the stylus movement is controlled for frequencies from 5 to up to 40 Hertz (Hz) and 41 Hz to 200 Hz);
Frequency (The stylus is moved such that its tip position follows a sine wave of the selected frequency or a chirp from a start frequency to a stop frequency with an amplitude of up to 3 mm);
and Maximum number of periods/cycles at specified frequency.

The treatment steps are read from the memory. Each treatment step is indexed and written to the Real Time Control data structure. A counter is incremented every time a period is complete. When the counter reaches the maximum, the next treatment step is indexed and the counter is reset. When all of the number of treatment periods is complete, the firmware will exit the treatment.

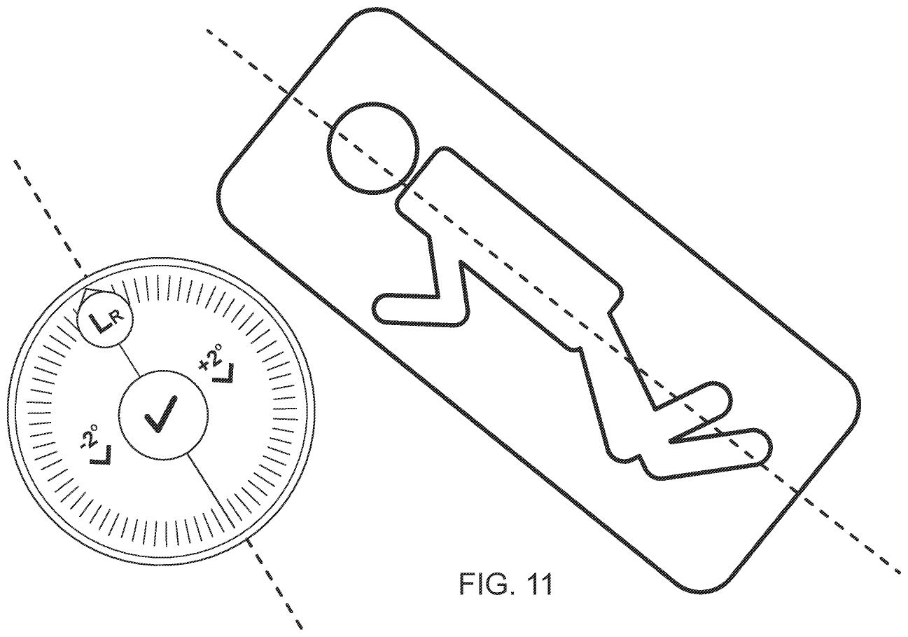

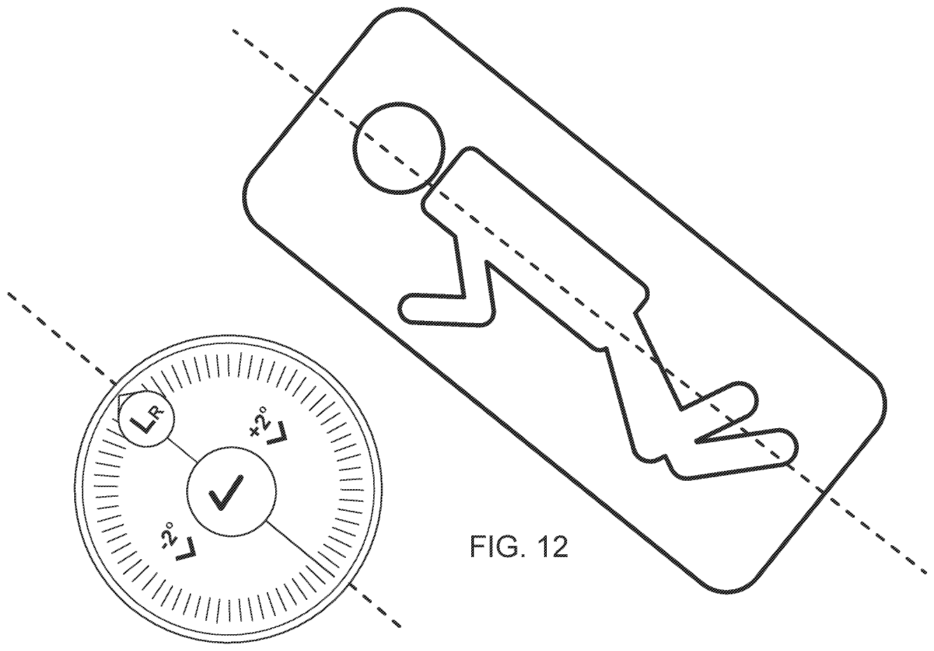

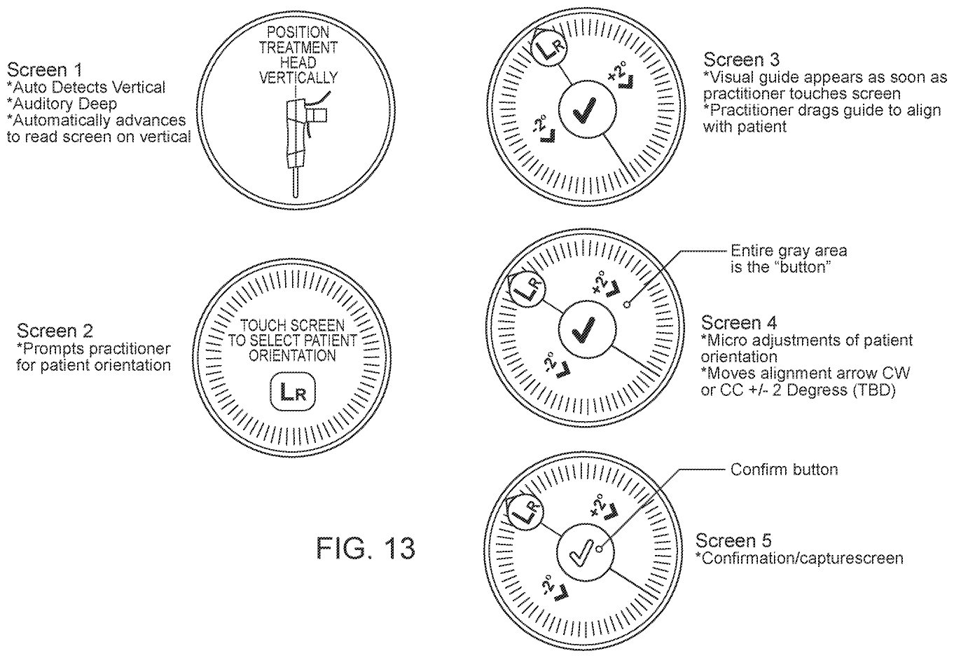

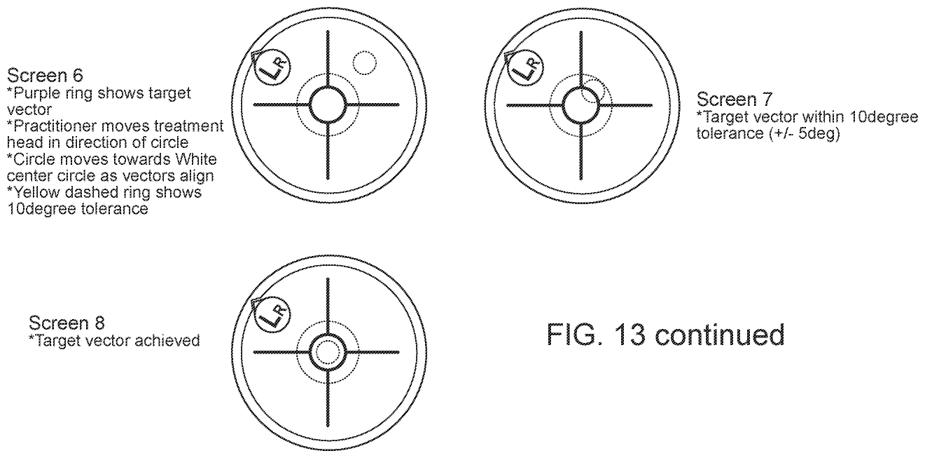

As shown in FIGS. 9 and 10, a practitioner positions the treatment head 12 vertically and selects the macro-orientation of the patient on the touch screen 200 of the computer 44 or the touch screen 54 on the treatment head 12 and pushes the “Next button” 202. The orientation of the patient is also shown in FIG. 10. As shown in FIG. 11, the touch screen 54 of the treatment head 12 shows a line that is not parallel to the longitudinal axis of the patient. The patient alignment dial 204 on the touch screen 54 moves in two degree increments until the line on the touch screen 54 is parallel to the longitudinal axis of the patient (see FIG. 12). Once the alignment has been achieved, it is confirmed by pressing the button in the middle of the patient alignment dial 204 and a treatment vector dial 206 appears. As shown in FIG. 13, the treatment vector dial 206 is used to align the treatment vector with the target vector for the patient. The solid circle 212 shows the target vector. By moving the treatment head 12, the practitioner aligns the target vector with the centre circle, which represents the treatment vector. The treatment can then commence. The treatment can be paused with any of the computing devices. The treatment can only be canceled using the computer 44.

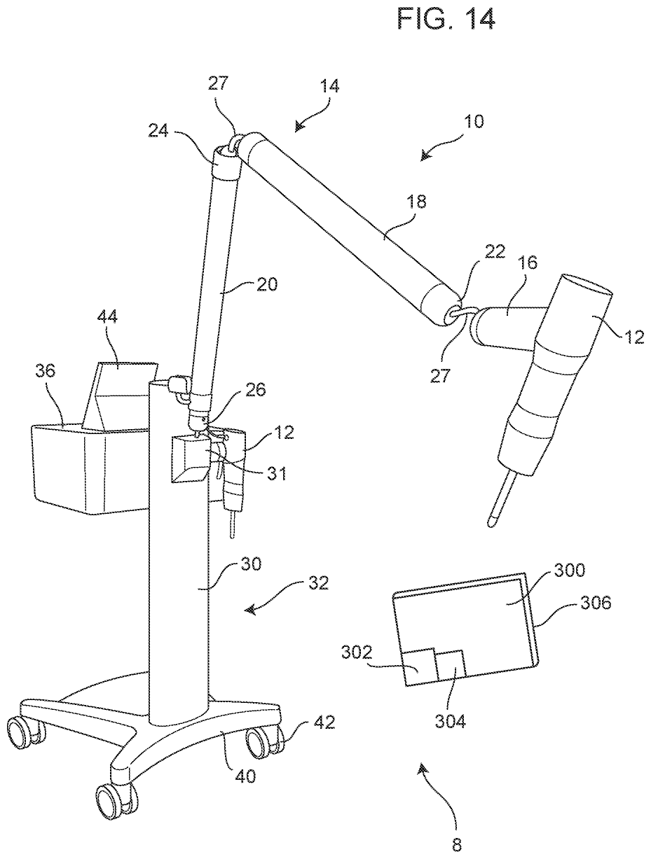

As shown in FIG. 14, in one embodiment, the impulse treatment system 8 includes a remote vibration sensor 300. The vibration sensor 300 includes an IMU 302, a Bluetooth radio 304 for communication with the firmware 74 or the computer 44 and an adhesive pad 306. The vibration sensor 300 is placed on the patient's lumbar spine and reports the characteristics of the vibration (force and amplitude) received at the vibration sensor 300.

During the administering of treatment, the primary form of communication between the treatment head 12 and the computer 44 is wireless and encrypted to provide complete security to treatment data. The workflow is as follows:

### Sleep State:

1. All LEDs and touch screens are off. Touch screen is unresponsive.
2. User powers treatment head up by pressing pushbutton for longer than 3 seconds.
3. Go to pairing state.

### Pairing State:

1. Checking communication screen is displayed.
2. The treatment head listens for received messages over the Universal serial bus (USB) connection.
3. If there is USB communication within 1 second, turn off Bluetooth and wait for password.
i. Password is written to a register by the computer.
a) If the password is entered incorrectly three times in a row, the master password is required.
ii. If the treatment head has not been configured, implement configuration sequence, (set password, set identification, set Bluetooth host identification).
iii. If the treatment head has been configured, display the online screen, move to Idle state.
4. If there is no USB communication and configuration has been complete previously, the treatment head listens for Bluetooth bonding requests. Bonding requests are sent by the computer.
i. Once bonding is complete, public keys are exchanged for encryption of communication.
ii. Display the online screen, move to Idle state.

### Idle State:

1. The treatment head continually scans the RFID reader for a stylus.
2. If the power button is held for more than 3 seconds, the treatment head goes to sleep state.
3. When a stylus is present, the stylus ID is stored in a register. The computer can read the stylus ID.
4. If stylus is accepted, the computer will write treatment configuration to registers. This includes treatment steps, angle of attack (treatment vector), and required force.
5. When all treatment configuration is written, a READY register in Modbus is set.
6. When READY register is set, the treatment head displays stylus accepted screen and moves to Pre-treatment state.

### Pre-Treatment State:

1. Treatment head displays self-test in progress screen.
2. Treatment head performs self-checks to ensure if hardware is in operating condition.
3. Treatment head displays head direction selection screen.
4. User presses circumference of screen to indicate head direction.
5. Treatment head displays head direction arrow on the screen in the direction selected.
6. User manually rotates the treatment head to fine tune the head direction.
7. User presses accept button and orientation screen is displayed. This is a cross hairs plus circular icon.
8. User tilts treatment head with tip of stylus at treatment site, to move icon into center of cross hairs. Treatment head reads gyroscope of IMU to determine actual orientation and calculates difference between actual orientation and angle of attack and moves icon accordingly.
9. When icon is centered in the crosshairs, treatment head displays button to accept orientation and displays force screen.
10. User adjusts treatment head along angle of attack to achieve required starting force.
11. Treatment head adjusts stylus colour to indicate force. When force is within range treatment head displays green stylus and displays force accept screen.
12. When user accepts the force, the treatment head displays the treatment start/continue screen.
13. The user presses the accept button on the screen or the button on the treatment head to move to treatment state.

### Treatment State

1. Treatment starts and the treatment in progress screen is displayed.
a. During treatment the treatment head activates the voice coil to generate the treatment.
b. Displays the time left.
c. Measures the stylus displacement.
d. Measures the average force.
e. Places the measured data in a log for later retrieval by the computer.
f. Checks for error conditions.
2. The treatment is stopped if one of the following occurs:
a. The treatment sequence is completed;
b. An error occurs;
c. The user aborts the treatment; or
d. The user pauses treatment.
3. At any point of the active treatment, the user can press the push button or the on-screen button to pause the treatment. A pause screen is displayed.
4. At any point of the active treatment, the computer can write to a register to abort treatment. A treatment aborted screen is displayed.
5. If an error is detected at anytime, the treatment head will move to Error state.
6. If the treatment is completed normally, the treatment head displays treatment complete screen.
7. If the pause screen is displayed, the treatment head waits for push button to be pressed or the resume button to be pressed, or for the computer to change the status to continue. The treatment in progress screen is displayed and treatment head completes the remaining treatment steps.
8. When the treatment complete or treatment aborted screen is displayed the user presses the accept button and treatment head returns to idle state.

### Error State:

1. An error screen is displayed, the error number or icon is displayed, and the user is prompted to acknowledge the error.
2. When the error is acknowledged, the treatment head goes to idle state.

A secondary USB wired communication link is available for servicing and firmware upgrades/downloads, as well as an alternate treatment communication link in the unlikely event of a failed Bluetooth link to enable the completion of treatment while waiting for service.

A processor in the computer 44 includes an artificial Intelligence (AI) algorithm and a processing and artificial Intelligence algorithm (PAIA) for calibrating and training the device. This algorithm identifies features of the signal received by the wireless radio from the position sensor 70, the load cell 72 and the IMU 80 for extraction, in order to train this algorithm and the generalized learning algorithm (GLA) to know the location of the stylus 50 and the treatment parameters (force, amplitude, duration, stylus to be used, treatment location on the patient) and to repeat that location and treatment parameters for subsequent treatments.

In another embodiment, the treatment head 12 is configured for home or remote use. The Bluetooth® radio 86 receives and sends messages to a computing device which in turn sends and receives messages to the practitioner's computing device 44 by WiFi or the like. The messages that are received include treatment protocols (force, amplitude, duration, stylus to be used, treatment location on the patient, number of treatments, time between treatments, etc.). The messages that are sent include confirmation of a treatment (force, amplitude, duration, stylus used, treatment location on the patient, number of treatments, time between treatments, etc.).

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. An impulse treatment device for use with a cart, the impulse treatment device comprising an articulating holding arm, an impulse treatment head, and a stylus, wherein
the articulating holding arm includes: a proximal joint for rotational attachment to the cart and which includes a ball joint which includes a ball, a socket, a spring to bias the ball to a locked position, and a linear solenoid to release the ball; a proximal section, which defines a bore and is attached to the proximal joint; a distal section which defines a bore and includes a distal end; and a pair of ball joints between the distal section and the proximal section, wherein the ball joints each include a ball, a spring to bias the ball to a locked position, a socket and a linear solenoid to release the ball; a bent arm extending between and attached to each of the balls of the pair of ball joints and wherein the articulating holding arm has a full range of motion and can be locked in any orientation;
the impulse treatment head includes: a distal end; a proximal end; a body therebetween; a touch screen on the proximal end; an actuator for driving the stylus in a linear direction; an internal motion unit (IMU), the impulse treatment head attached to the distal end of the distal section of the articulating holding arm; and
the stylus is slidably, releasably retained in the impulse treatment head and extends outward at the distal end and is releasably coupled to the actuator.

2. The impulse treatment device of claim 1, wherein the articulating holding arm further comprises a middle section which defines a bore; a pair of ball joints between the middle section and the proximal section, wherein the ball joints each include a ball, a spring to bias the ball to a locked position, and a linear solenoid to release the ball and a bent arm extending between and attached to each of the balls of the pair of ball joints.

3. The impulse treatment device of claim 2 wherein the impulse treatment head is attached at right angles to the distal section.

4. The impulse treatment device of claim 3, wherein the impulse treatment head further comprises a radio frequency identification (RFID) transponder and the stylus further comprises an RFID tag.

5. The impulse treatment device of claim 4, wherein the treatment head further comprises an internal motion unit (IMU).

6. The impulse treatment device of claim 5, wherein the treatment head further comprises firmware, the firmware in electronic communication with the IMU and configured to determine an orientation of the stylus and calculate a difference between the orientation and an angle of attack.

7. The impulse treatment device of claim 6, wherein the treatment head includes a touchscreen on the proximal end for adjusting and displaying the angle of attack.

8. The impulse treatment device of claim 7, wherein the distal section further comprises at least one controller, the controller in electrical communication with the linear solenoids of the ball joints.

9. The impulse treatment device of claim 8, wherein the impulse treatment head is releasably attached to the distal end of the distal section.

10. The impulse treatment device of claim 9 wherein a release mechanism for the impulse treatment head is located on the distal section.

11. An articulating holding arm for use with a medical treatment device, the articulating holding arm comprising: a proximal joint for rotational attachment to a support and which includes a ball joint, the ball joint including a ball, a socket, a spring to bias the ball to a locked position, and a linear solenoid to release the ball; a long proximal section, which defines a bore and is attached to the proximal joint; a short distal section which defines a bore and includes a distal end; and a pair of ball joints between the short distal section and the long proximal section, wherein the ball joints each include a ball, a socket, a spring to bias the ball to a locked position, and a linear solenoid to release the ball; and a bent arm extending between and attached to each of the balls of the pair of ball joints, wherein the articulating holding arm has a full range of motion and can be locked in any orientation.

12. The articulating holding arm of claim 11 wherein the ball joints further comprise an O-ring, the O-ring disposed between the ball and the socket.

13. The articulating holding arm of claim 12 further comprising a long middle section which defines a bore; a pair of ball joints between the long middle section and the long proximal section, wherein the ball joints each include a ball, a spring to bias the ball to a locked position, and a linear solenoid to release the ball; and a bent arm extending between and attached to each of the balls of the pair of ball joints.

14. The articulating holding arm of claim 13, wherein the short distal section further comprises at least one controller, the controller in electrical communication with the linear solenoids of the ball joints.

15. The articulating holding arm of claim 14, wherein the distal end of the short distal section includes a retention mechanism for retaining a medical device.

16. The articulating holding arm of claim 15, wherein a release mechanism for the retention mechanism is located on the short distal section.

17. The articulating holding arm claim 16, wherein the proximal joint is rotatably and articulately mounted to a mounting bracket which is configured to retain the articulating holding arm on a support.

18. An impulse treatment system for use with a cart, the impulse treatment system comprising, an articulating holding arm, an impulse treatment head, a computing device and a stylus, wherein
the articulating holding arm includes a proximal section, a middle section and a distal section and is configured to have a full range of motion, to be lockable in any orientation and to releasably retain the impulse treatment head on the distal section;
the impulse treatment head includes a proximal end, a distal end, an actuator for driving the stylus in a linear direction, firmware, a touchscreen in electronic communication with the firmware, the touchscreen located on the proximal end, and an IMU in electronic communication with the firmware, wherein the firmware is configured to record and report a treatment vector to the computing device;
the computing device includes software which is configured for calibrating and training the firmware and is in wired or wireless communication with the firmware in the impulse treatment head; and
the stylus is slidably, releasably retained in the impulse treatment head and extends outward at the distal end and is releasably coupled to the actuator.

19. A use of an impulse treatment system for the treatment of a patient, the impulse treatment system comprising a handheld impulse treatment head, a stylus and a computing device, the handheld impulse treatment head including: a distal end; a proximal end; a body therebetween; a touch screen on the proximal end; an actuator for driving the stylus in a linear direction; an IMU, firmware and a wireless radio;
the stylus is slidably, releasably retained in the handheld impulse treatment head and extends outward at the distal end and is releasably coupled to the actuator;
and the computing device includes a database of patient treatment vectors and is in wireless communication with the firmware in the handheld impulse treatment head, wherein:
the computing device provides a treatment vector to the firmware in the handheld impulse treatment head;
a user positions the handheld impulse treatment head on the patient;
the user aligns the treatment vector by viewing the display on the touchscreen of the handheld impulse treatment head and adjusting the position of the handheld impulse treatment head;
the user selects a treatment protocol;
and the patient is treated.
